(19) United States
(12) Patent Application Publication
(10) Pub. No.: US 2017/0050224 A1
(43) Pub. Date: Feb. 23, 2017

(54) Pressurized Fluid Cleaning System and Connector

(71) Applicant: Cameron International Corporation, Houston, TX (US)

(72) Inventor: Melissa Ann Simpson, Spring, TX (US)

(73) Assignee: CAMERON INTERNATIONAL CORPORATION, Houston, TX (US)

(21) Appl. No.: 14/832,776

(22) Filed: Aug. 21, 2015

(51) Int. Cl. B08B 9/032; F16L 21/02

(52) U.S. Cl. CPC B08B 9/0321; F16L 21/02

(57) ABSTRACT

A cleaning system is disclosed for using a pressurized fluid to clean the inside of a tubing. The system includes a fluid line configured to communicate the pressurized fluid. The system also includes a connector attached to the fluid line and configured to fluidly connect the fluid line with the inside of the tubing. The connector only allows a specific maximum pressure drop across the connector whether connected to the tubing or not.

### BACKGROUND

This section is intended to introduce the reader to various aspects of art that may be related to various aspects of the presently described embodiments. This discussion is believed to be helpful in providing the reader with background information to facilitate a better understanding of the various aspects of the described embodiments. Accordingly, it should be understood that these statements are to be read in this light and not as admissions of prior art.

Offshore drilling and production for oil and natural gas is conventionally done through a riser between a drilling structure at the water surface and subsea equipment such as a BOP stack, production tree, subsea test tree, etc., located at or near the seabed.

The functions of the subsea equipment, such as opening and closing valves, may be controlled by a hydraulic control system or an electro-hydraulic control system. Hydraulic control systems use hydraulic pressure conveyed from the surface directly to a particular hydraulic actuator on the subsea equipment by way of a discrete hydraulic conduit. “Piloted” subsea hydraulic control systems use “piloted” discrete hydraulic control systems, in which hydraulic pilot signals are conveyed down a dedicated hydraulic conduit to a pilot valve, which directs hydraulic pressure from a subsea hydraulic manifold to a particular hydraulic actuator on the subsea equipment. Other control systems are “discrete” electro-hydraulic systems, with one electrical conductor per hydraulic function, or “multiplexed” (or “MUX”) systems, in which coded signals are transmitted via a small number of conductors.

Regardless of the system, hydraulic control of subsea equipment includes the use of a complex nest-like system of hydraulic control tubes that must be arranged is a spatially restricted space. The hydraulic control tubes must be manufactured to custom layouts for each system and include custom lengths and bends in each tube to be able to navigate around equipment and other control tubes. The control tubes may be small diameter pipe, such as ¼ inch (6.35 mm) outside diameter (OD) tubing.

### BRIEF DESCRIPTION OF THE DRAWINGS

For a detailed description of the embodiments of the invention, reference will now be made to the accompanying drawings in which:

FIG. 1 depicts a schematic diagram of a compressed fluid cleaning system in accordance with one or more embodiments;

FIG. 2 depicts a cross sectional view of a connector for the cleaning system in accordance with one or more embodiments; and

FIG. 3 depicts a cross sectional view of another connector for the cleaning system in accordance with one or more embodiments.

### DETAILED DESCRIPTION

During and after manufacturing of subsea hydraulic control system, the hydraulic control tubes must be purged clean of any impurities before final installation. One method of cleaning the tubes is to attach a source of pressurized fluid such as air to one end of the control tube and releasing the pressurized fluid to create a pressure drop across the tube that forces impurities out the other end of the tube. Connecting the source of pressurized fluid must be done so as not to damage or affect the integrity of the control tube with any tool marks or other physical damage. Additionally, government safety regulations may require a certain maximum pressure drop across the connection to the source of pressurized air. For example, the United States Occupational Safety & Health Administration (OSHA) requires compressed air used for cleaning to only have a downstream pressure at the nozzle or connector of 30 psi (206.8 kPa) (OSHA Directive STD 01-13-001; Standard 1910.242(b); Oct. 30, 1978). This requirement addresses concerns with backpressure buildup in case the nozzle is obstructed or dead-ended.

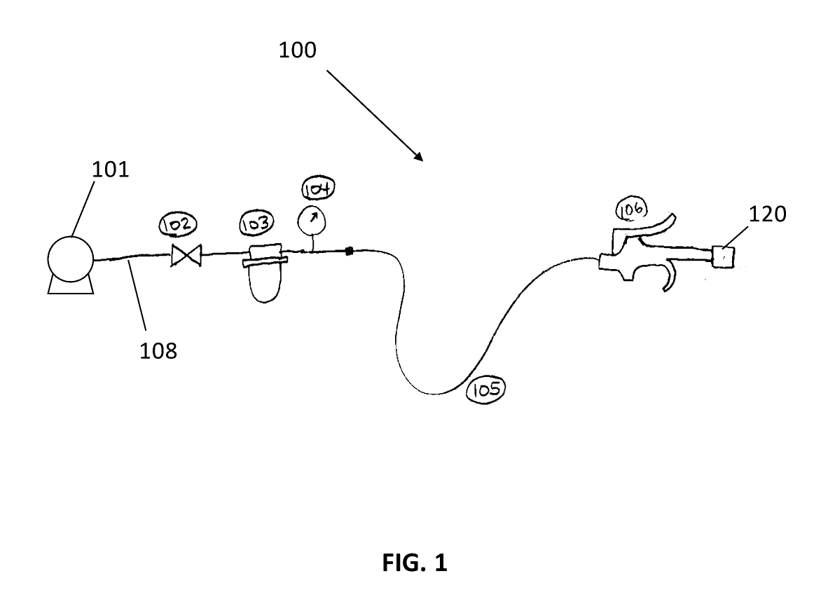

FIG. 1 shows a schematic representation of a compressed fluid cleaning system 100 for cleaning the inside of tubing, such as high-pressure tubing (not shown). The cleaning system 100 includes a compressor 101 used to pressurize a fluid, such as air, to preferably at least 90-100 psi (620.53-689.48 kPa). The compressor 101 may be any suitable type of compressor, such as an electric or combustion engine compressor.

As shown, the system 100 further includes a fluid line 108 for communicating pressurized fluid from the compressor 101. The fluid line may be any suitable type of rigid or flexible line for carrying fluid under pressure from the compressor 101. Optionally, the fluid line 108 further includes a shutoff valve 102, an air filter/regulator 103, and a pressure gauge 104.

Connected to the fluid line 108 is also a flexible fluid line 105. The flexible fluid line 105 may be a flexible fluid line made of synthetic rubber and may be ⅜ inch (0.95 cm) ID line, for example. However, the flexible fluid line 105 may be any suitable type of flexible fluid line for carrying fluid under pressure from the fluid line 108.

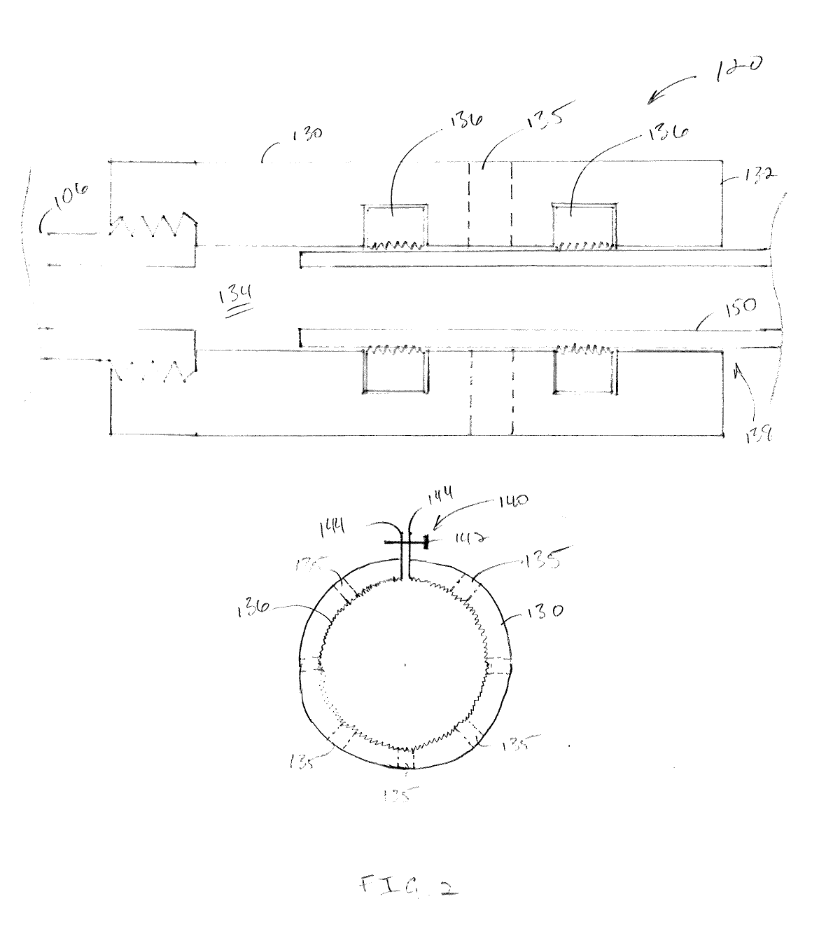

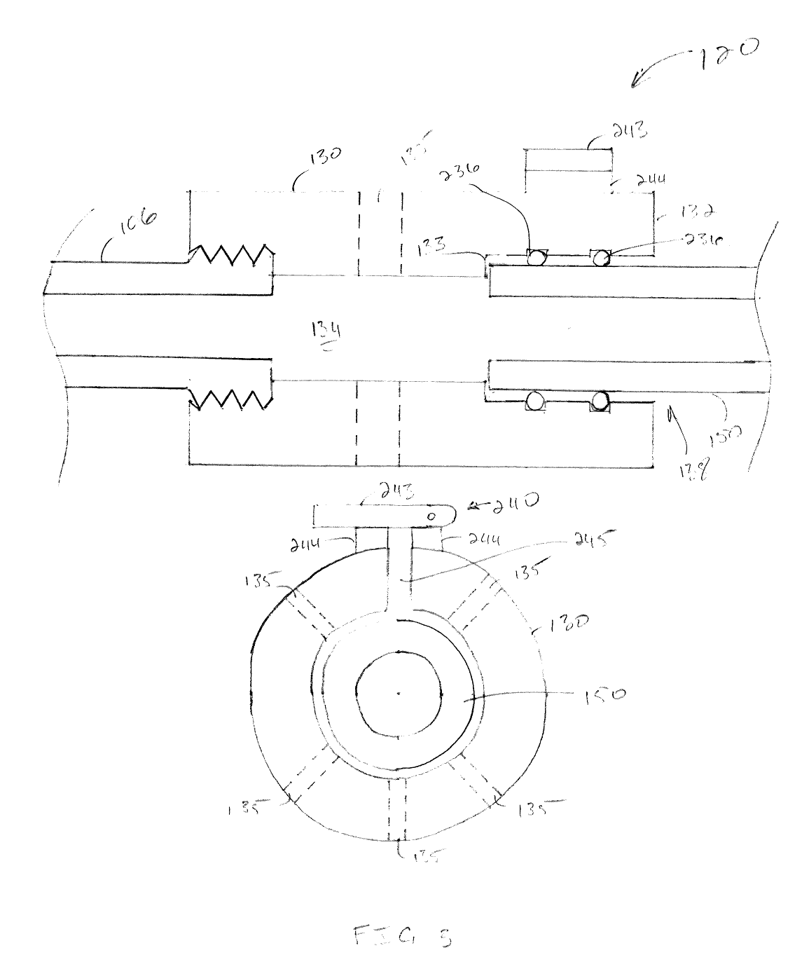

Attached to the end of the flexible fluid line 105 is a valve 106, which may be an air gun 106 as shown in FIG. 1, which includes a connector 120. The connector 120 is used to releasably attach the system 100 to an end of the tubing to be cleaned without damaging the tubing such as by galling, scratching, tool marks, or any other type of damage. The connector 120 is designed for a specific downstream pressure for all static conditions whether the connector is attached to the tubing or not. For example, the downstream pressure of the end connector may be 50 psi (344.74 kPa) when attached to the tubing as shown in FIGS. 2 and 3, but the pressure at the other end of the tubing 150 may be 30 psi (206.8 kPa). In another example, the downstream pressure of pressurized fluid at the connector 120 may be 30 psi (206.8 kPa) when not attached to the tubing 150. Thus, when the connector 120 is not attached to the tubing 150, the maximum downstream pressure of the compressed air coming out of the fluid line/connector 120 would be 30 psi (206.8 kPa). This design is a safety feature that reduces the concerns with backpressure buildup in case the nozzle is obstructed or dead-ended.

FIG. 2 shows an embodiment of the connector 120 including a body 130 with a wall 132 surrounding an interior space 134. The connector 120 further includes seals 136 on the inside of the wall 132 for sealing against the outside of the tubing 150 to be cleaned. The seals 136 may be any suitable type of shape and material for sealing against the tubing 150 that does not damage the tubing 150, such as a nitrile butadiene rubber (NBR). The body 130 includes an open end 138 for receiving the tubing 150 and may be designed to accommodate a specific size, or a range of sizes, of tubing.

To adjust for and seal against the tubing, the connector 120 may include an attachment mechanism 140 that realeasably attaches the connector 120 to the tubing 150. In the embodiment shown in FIG. 2, the attachment mechanism 140 includes a screw-adjustment mechanism that includes a screw 142 extended through two tabs 144. Turning the screw either moves the tabs 144 together or apart to tighten or loosen the connector 120's attachment to the tubing respectfully.

The connector 120 also includes a connection for attachment to the fluid line 106. In FIG. 2, the connector 120 is threadingly attached to the fluid line 106. However, the connection may be any suitable type of connection.

The connector 120 also includes one or more fluid flow paths 135 from the interior 134 through the wall 132 to the outside of the body 130. The fluid flow paths 135 act to diffuse fluid flowing out the connector 120 when not connected to the tubing 150. The number (one or more), size, and shape of the flow paths 135 may be designed to control the overall pressure drop across the connector 120 to meet the designed pressure drop limit.

For cleaning the tubing 150, the compressor 101 is operated to provide pressurized fluid at a desired pressure. The fluid line 105 is then releasably connected to the tubing 150 using the connector 120. Once properly connected, fluid from the compressor 101 may be released through the connector 120 and into the interior of the tubing 150, creating a pressure drop across the tubing 150 such that the pressurized fluid flows through the tubing 150. The inside of the tubing 150 may thus be cleaned as the fluid flow removes unwanted material from the inside of the tubing 150. When the tubing 150 is sufficiently cleaned, the flow of pressurized fluid may be turned off and the tubing 150 removed from the connector 120.

FIG. 3 shows a second embodiment of a connector 120 for use with the cleaning system 100. Like parts with the embodiment shown in FIG. 2 will be given like reference numbers. The connector 120 in FIG. 3 similarly includes a body 130 with a wall 132 surrounding an interior space 134. The connector 120 further includes seals 236 on the inside of the wall 132 for sealing against the outside of the tubing 150 to be cleaned. The seals 236 may be any suitable type of shape, such as an o-ring configuration as shown or a rectangular cross section, and material, such as NBR, for sealing against the tubing 150. The body 130 includes an open end 138 for receiving the tubing 150 and may be designed to accommodate a specific size, or a range of sizes, of tubing. The connector 120 also includes an internal stop shoulder 133 of a smaller dimension than an outside dimension of the tubing 150. This allows the tubing 150 to be inserted into the connector 120 only to a specific point, providing feedback to the user to confirm that the tubing has been inserted into the connector 120 to the desired location.

To adjust for and seal against the tubing, the connector 120 may include an attachment mechanism 240 used to realeasably attach the connector 120 to the tubing 150. In the embodiment shown in FIG. 3, the attachment mechanism 240 includes a “quick release” adjustment mechanism that includes a lever 243 that is rotatable between a released and connected positions. FIG. 3 shows the lever 243 in the connected position. As the lever 243 rotates from the released position to the connected position, the lever 243 operates a cam to pull the two tabs 144 together, tightening the connector 120's attachment to the tubing 150 and making a space 245 between the tabs 144 smaller. Moving the lever 243 to the released position allows the tabs 144 to move apart, loosening the connector 120's attachment to the tubing. The attachment mechanism 240 may also include a fine adjustment mechanism that changes the positions of the tabs 244 when the lever 243 is in the released and connected positions.

The space 245 between the tabs 144 acts to diffuse fluid flowing out of the connector when not connected to the tubing 150. In addition to the flow path created by the space 245 of the attachment mechanism 240, the connector 120 may also include one or more fluid flow paths 135 from the interior 134 through the wall 132 to the outside of the body 130. The fluid flow paths 135 act to diffuse fluid flowing out the connector 120 when not connected to the tubing 150. The number, size, and shape of the flow paths 135 may be designed to control the overall pressure drop across the connector 120 to meet the designed pressure drop limit.

As with the embodiment shown in FIG. 1, for cleaning the tubing 150, the compressor 101 is operated to provide pressurized fluid at a desired pressure. The fluid line 105 is then releasably connected to the tubing 150 using the connector 120 shown in FIG. 3. Once properly connected, fluid from the compressor 101 may be released through the connector 120 and into the interior of the tubing 150, creating a pressure drop across the tubing 150 such that the pressurized fluid flows through the tubing 150. The inside of the tubing 150 may thus be cleaned as the fluid flow removes unwanted material from the inside of the tubing 150. When the tubing 150 is sufficiently cleaned, the flow of pressurized fluid may be turned off and the tubing 150 removed from the connector 120.

This discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to intimate that the scope of the disclosure, including the claims, is limited to that embodiment.

Certain terms are used throughout the description and claims to refer to particular features or components. As one skilled in the art will appreciate, different persons may refer to the same feature or component by different names. This document does not intend to distinguish between components or features that differ in name but not function, unless specifically stated. In the discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

Although the present invention has been described with respect to specific details, it is not intended that such details should be regarded as limitations on the scope of the invention, except to the extent that they are included in the accompanying claims.

1. A cleaning system for using a pressurized fluid to clean the inside of a tubing, the system including:
a fluid line configured to communicate the pressurized fluid;
a connector attached to the fluid line and configured to fluidly connect the fluid line with the inside of the tubing; and
wherein the connector is configured to allow a specific maximum pressure drop across the connector when not connected to the tubing.

2. The system of claim 1, wherein the specific maximum pressure drop across the connector when not connected to the tubing is 30 psi.

3. The system of claim 1, the connector further being configured to be releasably attachable to an end of the tubing without damaging the tubing.

4. The system of claim 1, further including a compressor in fluid communication with the fluid line and configured to pressurize the fluid.

5. The system of claim 1, the connector further including seals configured to seal against the tubing when the connector is attached to the tubing.

6. The system of claim 5, the connector further including an attachment mechanism configured to releasably attach the connector to the tubing.

7. The system of claim 6, the attachment mechanism further comprising a quick release mechanism.

8. The system of claim 1, the connector comprising a body comprising:
a wall surrounding an interior; and
a fluid flow path from the interior through the wall.

9. The system of claim 8, further comprising more than one fluid flow path through the wall.

10. The system of claim 1, the connector further comprising an internal stop shoulder of a smaller dimension than an outside dimension of the tubing.

11. The system of claim 1, further comprising a valve configured to control communication of the pressurized fluid to the connector.

12. A connector for a fluid cleaning system for using a pressurized fluid to clean the inside of a tubing, the connector configured to connect to the tubing and allow a specific maximum pressure drop across the connector when not connected to the tubing.

13. The connector of claim 12, wherein the specific maximum pressure drop across the connector when not connected to the tubing is 30 psi.

14. The connector of claim 12, the connector further being configured to be releasably attachable to an end of the tubing without damaging the tubing.

15. The connector of claim 12, the connector further including seals configured to seal against the tubing when the connector is attached to the tubing.

16. The connector of claim 15, the connector further including an attachment mechanism configured to releasably attach the connector to the tubing.

17. The connector of claim 16, the attachment mechanism further comprising a quick release mechanism.

18. The connector of claim 12, the connector comprising a body comprising:
a wall surrounding an interior; and
a fluid flow path from the interior through the wall.

19. The connector of claim 18, further comprising more than one fluid flow path through the wall.

20. The connector of claim 1, the connector further comprising an internal stop shoulder of a smaller dimension than an outside dimension of the tubing.
